(19) United States
(12) Patent Application Publication
(10) Pub. No.: US 2017/0157995 A1
(43) Pub. Date: Jun. 8, 2017

(54) Tire Comprising a Mark Formed by a Plurality of Linear Patterns

(71) Applicants: COMPAGNIE GENERALE DES ETABLISSEMENTS MICHELIN, Clermont-Ferrand (CH); MICHELIN RECHERCHE ET TECHNIQUE S.A., Granges-paccot (CH)

(72) Inventor: Olivier MUHLHOFF, Chermont-Ferrand Cedex 9 (FR)

(21) Appl. No.: 15/325,677

(22) PCT Filed: Jul. 10, 2015
(86) PCT No.: PCT/EP2015/065864

§ 371 Date: Jan. 11, 2017

(30) Foreign Application Priority Data
Jul. 11, 2014 (FR) 1456698

(51) Int. Cl. B60C 13/00; B29D 30/72; B60R 13/00; B60C 11/24; B60C 13/02; B29D 30/08; B44C 1/00

(52) U.S. Cl. CPC B60C 13/001; B29D 30/08; B29D 30/72; B44C 1/00; B60C 11/24; B60C 13/02; B60R 13/00

(57) ABSTRACT

A tire (1) made of rubber material, comprising a tread (2) and a sidewall (3). The tire (1) comprises a marking (4) on the tread (2) and/or the sidewall (3). The marking (4) is formed by a plurality of linear motifs formed integrally with the tire, the motifs being mutually parallel and spaced apart by a spacing P less than or equal to 1 mm, each linear motif having a length. All or some of the linear motifs (41) have one or more variations in width (Lt) along their length so as to define the marking.

### FIELD OF THE INVENTION

The present invention relates to a tire for a motor vehicle, having a tread and a sidewall, said tire comprising a marking on the tread and/or said sidewall.

### PRIOR ART

For aesthetic reasons, tires have markings on their treads and/or their sidewalls which are produced increasingly from source images which are printed and which are notably photographs, or works by artists or graphic designers. Said source images are made up of different shades of colour which are able to be transposed into different corresponding grey levels.

The document WO 2013/113526 discloses a tire having a marking on a sidewall. This marking consists of a realistic representation of a photograph. More particularly, the marking is made up of a plurality of adjacent ribs having a triangular overall section. The space between two adjacent ribs is filled with a complementary material to a particular filling level. The filling level of the complementary material locally determines a grey level of the marking.

The aim of the invention is to propose a solution that makes it possible to realize complex markings, of the photographic representation type, on a tire in a simpler and more economical manner than in the prior art.

### DEFINITIONS

A “tire” means all types of resilient tread, whether or not it is subjected to an internal pressure.

A “rubber material” means a diene elastomer, that is to say, in a known way, an elastomer which is based, at least partially (i.e. is a homopolymer or a copolymer), on diene monomers (monomers bearing two conjugated or non-conjugated carbon-carbon double bonds).

The “tread” of a tire means a quantity of rubber material delimited by lateral surfaces and by two main surfaces, one of which, referred to as the tread surface, is intended to come into contact with a road surface when the tire is being driven on.

The “sidewall” of a tire means a lateral surface of the tire, said surface being disposed between the tread of the tire and a bead of this tire.

A “strand” means a filiform element, the height of which is at least equal to twice the diameter of a disc having the same surface area as the mean cross section of the strand.

“Lamellae” means elongate strands which have a length at least equal to twice their height.

A linear motif means one or more geometric elements protruding from the tire, such as a strand or lamella, and/or one or more geometric elements recessed into the tire, such as a hole or striation.

A linear motif “formed integrally with the tire” means that this motif is made of the same material as the tire.

“Lightness” means the parameter which characterizes a surface to reflect light to a greater or lesser extent. Lightness is expressed using a scale that ranges from 0 to 100 according to the L*a*b* colour model established by the CIE (International Commission on Illumination) in 1976. The value 100 represents white or total reflection; the value 0 represents black or total absorption. In this colour model, a* and b* are chromaticity coordinates. The L*a*b* colour model thus defines a chromaticity diagram. In this diagram, a* and b* indicate the direction of the colours: +a* goes towards red, −a* towards green, +b* towards yellow, and -b* towards blue. The centre of the diagram is achromatic. Saturation increases as the values a* and b* rise and thus with increasing distance from the centre of the diagram.

### SUMMARY OF THE INVENTION

The invention relates to a tire made of rubber material, comprising a tread and a sidewall, said tire comprising a marking on said tread and/or said sidewall. The marking is formed by a plurality of linear motifs formed integrally with the tire. These motifs are mutually parallel and spaced apart by a spacing P less than or equal to 1 mm Each linear motif has a length L. All or some of the linear motifs have one or more variation(s) in width along their length L so as to define the marking.

The invention thus proposes producing a complex marking on a tire. This marking is produced from a plurality of linear motifs, these motifs having one or more variation(s) in width along their length. Depending on the given variations in width, it is possible to give the marking a degree of definition and, for example, it is possible to reproduce the details of a photograph with sufficient precision. Given that the motifs are formed directly on the tire, it is not necessary to add an additional material as in the prior art. The production of the complex marking on the tire is thus simplified.

According to non-limiting embodiments, the tire may also have one or more additional features from the following:

In one non-limiting embodiment, the marking is a representation of a photograph.

By virtue of the invention, it is thus possible to produce complex markings that give the tire a degree of visual attractiveness.

In one non-limiting embodiment, the linear motifs are disposed obliquely in the marking.

This makes it possible to obtain an aesthetic effect of the marking on the tire. It will be noted that these linear motifs can follow the curvature of the surface of the tire.

In one non-limiting embodiment, a linear motif is made up of one or more elements protruding from the tread and/or said sidewall or one or more elements recessed into the tread and/or said sidewall.

This makes it possible to obtain a motif of the “velvet” type in terms of touch or appearance.

In one non-limiting variant embodiment, all or some of the protruding elements are strands distributed through the linear motif at a density at least equal to one strand per square millimeter (mm²), each strand having a mean cross section of between 0.0005 mm² and 1 mm².

In one non-limiting variant embodiment, all or some of the protruding elements are substantially mutually parallel lamellae, the spacing of the lamellae in the linear motif being at most equal to 0.5 mm, each lamella having a mean width of between 0.02 mm and 0.25 mm.

In one non-limiting variant embodiment, all or some of the protruding elements form parallelepipeds having a side length of between 0.05 mm and 0.5 mm and a height of between 0.05 mm and 0.5 mm, the distance between two adjacent parallelepipeds in the linear motif being between 0.05 mm and 0.5 mm.

In one non-limiting variant embodiment, the recessed elements form openings in the tread and/or sidewall and the linear motif comprises a plurality of openings, these openings being distributed through the linear motif at a density at least equal to one opening per square millimeter (mm²), these openings having equivalent diameters of between 0.01 mm and 1.2 mm.

### BRIEF DESCRIPTION OF THE DRAWINGS

Other features and advantages of the invention will become apparent from the following description, given by way of non-limiting example, with reference to the attached drawings in which:

FIG. 1 schematically shows a perspective view of a part of a tire having a tread and a sidewall, said sidewall comprising a marking in accordance with the invention according to a first embodiment;

FIG. 2 schematically shows a perspective view of a part of a tire having a tread and a sidewall, said tread comprising a marking in accordance with the invention according to a second embodiment;

FIG. 3 schematically shows an enlarged view of the marking from FIG. 1 or FIG. 2, said marking being made up of a plurality of strips that each comprise a linear motif with a locally variable width;

FIG. 4 shows the plurality of strips from FIG. 3 without the linear motifs;

FIG. 5 shows a strip from FIG. 4, said strip being made up of a plurality of parts;

FIG. 6 shows a part of a strip from FIG. 5, said strip comprising a linear motif with a variable width;

FIG. 7 shows a linear motif from FIG. 3, according to a first non-limiting variant embodiment of a first embodiment of the linear motif, according to which the linear motif is made up of protruding elements;

FIG. 8 shows a linear motif from FIG. 3, according to a second non-limiting variant embodiment of a first embodiment of the linear motif, according to which the linear motif is made up of protruding elements;

FIG. 9 shows a linear motif from FIG. 3, according to a third non-limiting variant embodiment of a first embodiment of the linear motif, according to which the linear motif is made up of protruding elements;

FIG. 10 shows a linear motif from FIG. 3, according to a second embodiment of the linear motif, according to which the linear motif is made up of recessed elements;

FIG. 11 shows an enlarged view of a cavity of a recessed element from FIG. 10;

FIG. 12 is a flowchart of a method for producing a marking, such as the marking from FIG. 3, on a tire from a source image; and

FIG. 13 is a flowchart of the method from FIG. 12, said method comprising additional steps.

In the following description, elements which are substantially identical or similar will be denoted by identical references.

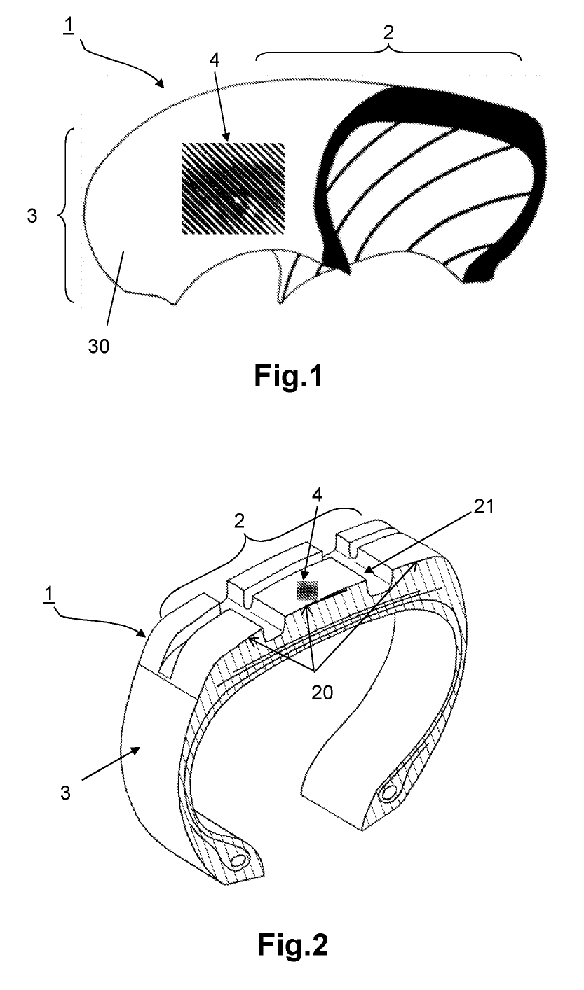

FIGS. 1 and 2 show a part of the tire 1 having a tread 2 and a sidewall 3, said tire 1 comprising a marking 4 on the tread 2 and/or said sidewall 3.

In the non-limiting example illustrated, said marking 4 represents a unit of meaning which in this case is an eye.

FIG. 1 shows a part of the tire 1 having a tread 2 and a sidewall 3 according to a first non-limiting embodiment. According to this embodiment, the sidewall 3 has the marking 4 on its surface 30.

FIG. 2 shows a part of the tire 1 having a tread 2 and a sidewall 3 according to a second non-limiting embodiment. The tread 2 has grooves 21 (also referred to as tread patterns) and a tread surface 20 intended to come into contact with the ground. According to this embodiment, the tread 2 has the marking 4 on its tread surface 20.

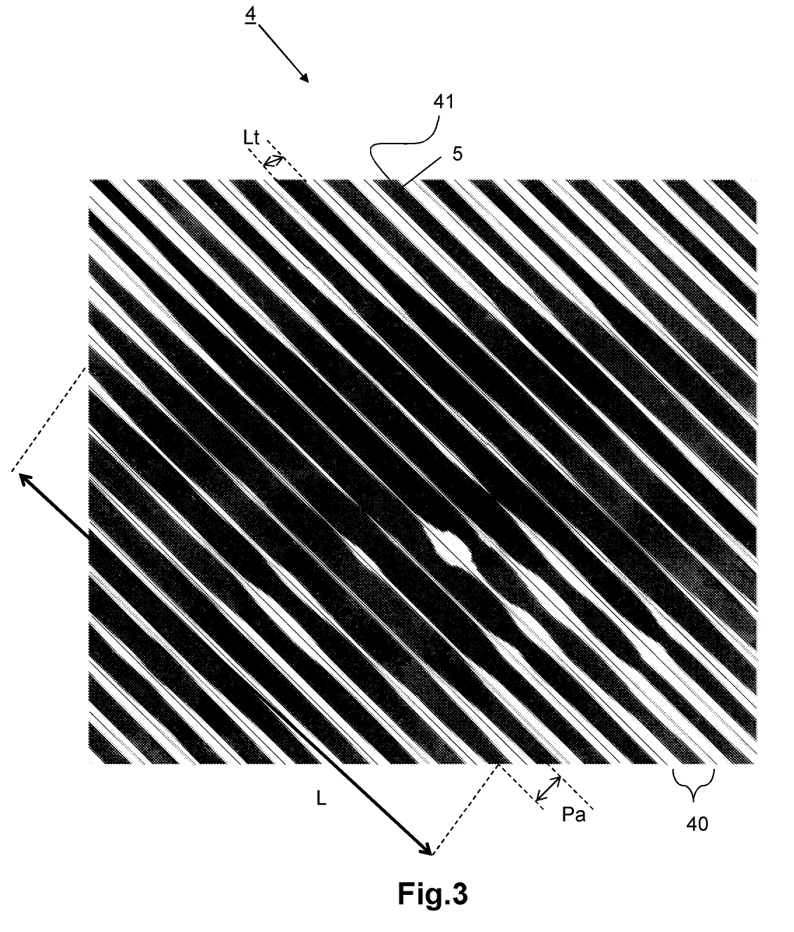

According to the two embodiments in FIGS. 1 and 2, as illustrated in the enlarged view of the marking (FIG. 3), said marking 4 is made up of a plurality of strips 40, each strip 40 comprising a linear motif 41, the width Lt of which can vary locally. Thus, all or some of the linear motifs 41 have one or more variations in width along their length so as to define said marking 4.

It will furthermore be noted that the variation in said width makes it possible to reproduce grey levels Nx. The marking 4, as seen by the observer, thus has variations of grey. In one non-limiting embodiment illustrated in FIG. 3, the width Lt of a linear motif 41 varies with respect to the median line of a strip 40.

In one non-limiting embodiment, as can be seen in FIG. 3, the linear motifs 41 are disposed obliquely in the marking 4. This makes it possible to determine the aesthetics to be given to the marking. In other non-limiting embodiments, it is conceivable to have horizontal or vertical linear motifs 41.

It will be noted that the linear motifs 41 can have a certain curvature since they follow the surface of the sidewall 3 or tread 2. They thus follow the shape of the tire 1.

In one non-limiting embodiment, a motif 41 is linear over the entire marking 4. It extends over the entire marking 4. Thus, it extends from a first limit of the marking 4 to a second limit, the limits of the marking 4 being defined by the four sides of said marking 4 in the example in question in FIG. 3. In the case in which the linear motif is vertical or horizontal, the first limit is situated opposite the second limit.

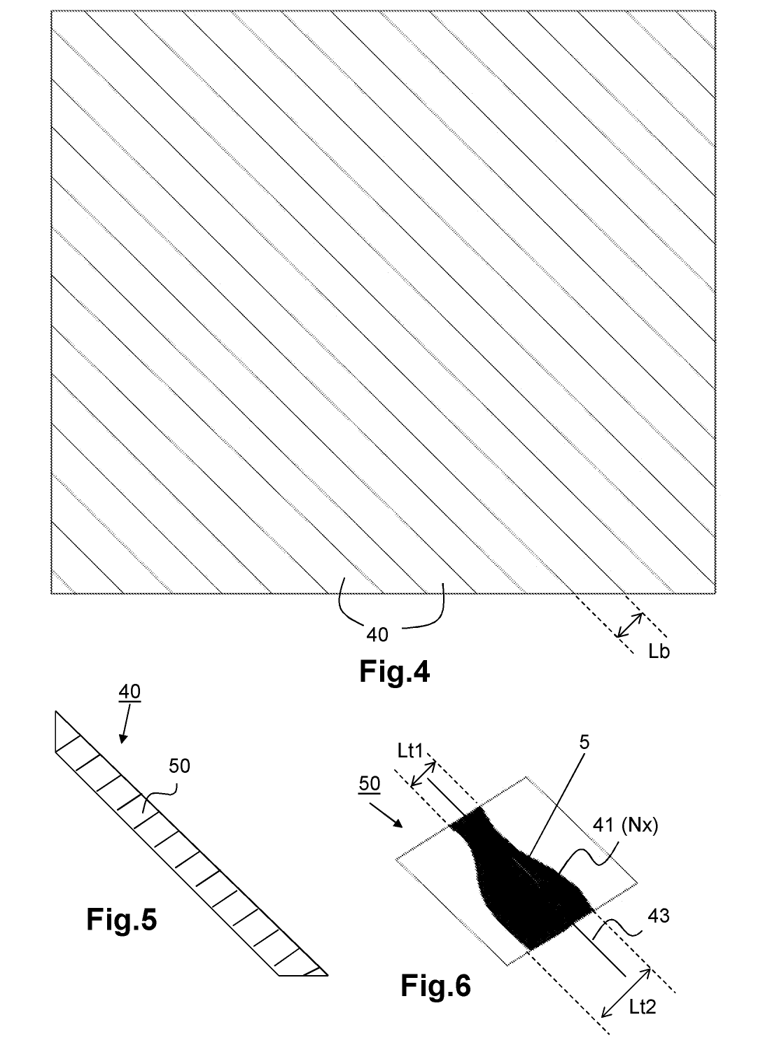

FIG. 4 illustrates the strips 40 from FIG. 3 without the linear motifs 41.

In one non-limiting embodiment, as can be seen in FIG. 4, the strips 40 are disposed obliquely in the marking 4, like the linear motifs 41 illustrated in FIG. 3.

Furthermore, in one non-limiting embodiment, the width Lb of a strip is between 0.03 mm and 1 mm. This makes it possible to produce a marking on the industrial scale in which the subject, in this case the unit of meaning, is visible. Specifically, if said width Lb were smaller, an observer of the tire would no longer perceive the details of the marking (in this case the unit of meaning which is an eye), and consequently would no longer know what the marking represents (unit of meaning, or another, abstract subject). It would be the same if said width were too large.

In one non-limiting variant embodiment, the width Lb is equal to 0.1 mm. This allows a good compromise between the definition of the marking obtained, as seen by an observer at a minimum distance of 1 m, and its resistance to mechanical attack.

In the example in question in FIG. 4, the strips 40 have the same width Lb overall. The strips enclose the linear motifs, making it possible to produce said motifs more easily on the industrial scale. In another non-limiting embodiment, the strips 40 have different widths Lb.

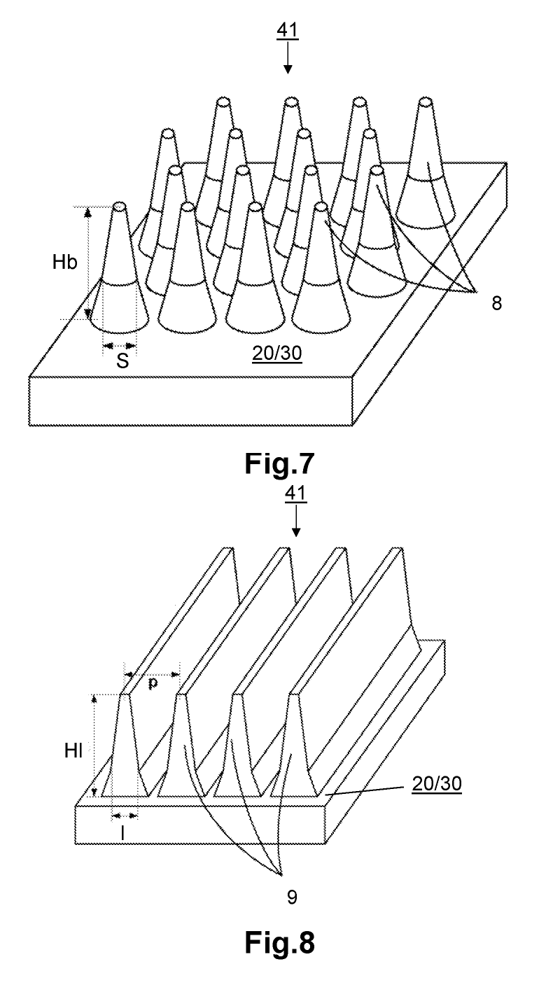

FIG. 5 illustrates a strip from FIG. 4. Said strip 40 is made up virtually of a plurality of parts 50, a part 50 defining a given grey level Nx which is realized by the local variation in the width Lt of said linear motif 41 in said part 50. Such a part 50 is shown in FIG. 6. As can be seen, the linear motif 41 varies inside said part 50 and comprises a width of size Lt1 on one side of the part 50 which is different from the size Lt2 on the other side of the part in the example in FIG. 6. In the non-limiting example illustrated, the width Lt varies about a median line 43 of the strip 40 (and thus of the part 50).

Thus, a grey level Nx is equal to the ratio between the surface area of said linear motif 41 in the part 50 comprising said linear motif 41, divided by the total surface area of said part 50. It is thus the proportion of the surface area of the linear motif 41 with respect to the surface area of the entire part 50 which defines a grey level Nx.

Thus, “local variation in the width of a linear motif 41” means that the linear motif 41 is not uniform through the entire strip 40. Its width Lt can vary from one part 50 to another or within one and the same part 50. It may be noted that one or more linear motifs 41 can have a constant width Lt along the entire length of the strip 40, while the other linear motifs 41 have a width Lt that varies locally.

In non-limiting embodiments, a linear motif 41 is made up of one or more elements protruding from the tread 3 and/or said sidewall 2 or one or more elements recessed into the tread 3 and/or said sidewall 2.

It will be noted that, in one non-limiting embodiment, a linear motif 41 (such as strands or lamellae) is formed integrally with the tread and/or said sidewall 3, i.e. it is produced from the same rubber material as said tread and/or said sidewall. A marking is thus obtained without addition of a further material.

A linear motif 41 contrasts with the tread 2 and/or sidewall 3 such that the marking 4 is clearly visible to an observer of the tire.

Different variant embodiments of the protruding elements are presented below. The effect of these protruding elements is to “trap” a large amount of the incident light rays that strike the linear motif 41. In this first embodiment (protruding elements), the linear motif 41 makes it possible to obtain not only a visual appearance of the “velvet” type since the protruding elements absorb light and thus make the linear motifs 41 blacker and consequently make the marking 4 contrast more with the tire, but also a touch of the “velvet” type, said protruding elements providing a marking 4 that is pleasant to the touch.

FIG. 7 illustrates a part of the linear motif 41 according to a first non-limiting variant embodiment of the first embodiment. In this variant, all or some of the protruding elements are strands 8 distributed through the linear motif 41 at a density at least equal to one strand per square millimeter (mm²), each strand having a mean cross section S of between 0.0005 mm² and 1 mm². It will be noted that the mean cross section of each strand corresponds to the mean of the cross sections S measured at regular intervals from the base of the strand. The strands 8 have a conical overall shape with a cross section that decreases over the height Hb of these strands.

FIG. 8 illustrates a part of the linear motif 41 according to a second non-limiting variant embodiment of the first embodiment. In this variant, all or some of the protruding elements are substantially mutually parallel lamellae 9, the spacing P of the lamellae in the linear motif 41 being between 0.1 mm and 0.5 mm, each lamella 9 having a mean width of between 0.02 mm and 0.25 mm. It will be noted that the mean width corresponds to the mean of the widths 1 measured at regular intervals over the height Hl of the lamella, the height of each lamella being between 0.05 and 0.5 mm.

In another non-limiting variant embodiment, the linear motif 41 is made up of only one lamella 9, the width of which can vary locally.

In another variant embodiment, the linear motif 41 has a combination of strands 8 and lamellae 9.

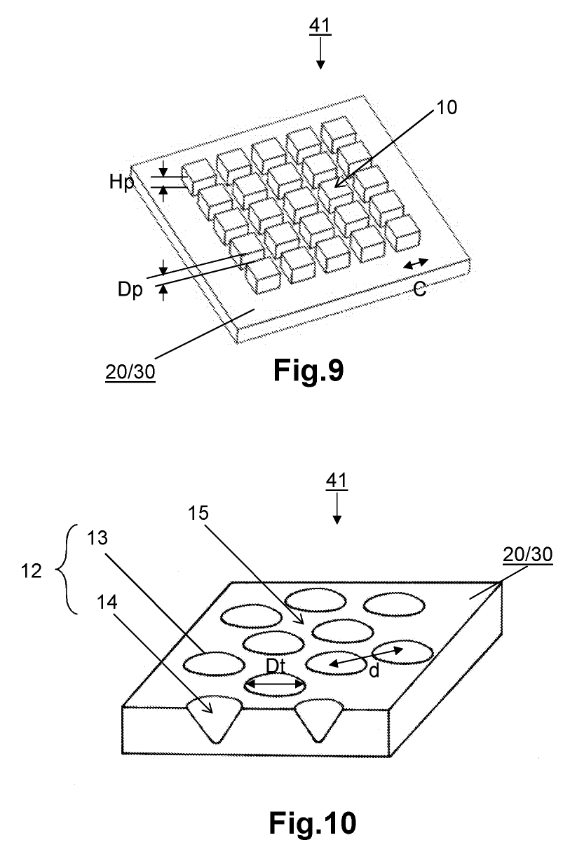

FIG. 9 illustrates a part of the linear motif 41 according to a third non-limiting variant embodiment of the first embodiment. In this variant, all or some of the protruding elements form parallelepipeds 10 having a side length C of between 0.05 mm and 0.5 mm and a height Hp of between 0.05 mm and 0.5 mm, the distance Dp between two adjacent parallelepipeds 10 in the linear motif being between 0.05 mm and 0.5 mm.

In another variant embodiment, the linear motif 41 has a combination of elements in relief 8, 9 and 10, or 8 and 10, or 9 and 10 described above.

According to the second non-limiting embodiment, the linear motif 41 comprises a plurality of elements 12 recessed into the surface where said linear motif 41 is located, namely the surface 30 of the sidewall 3 in the case illustrated in FIG. 1 or the tread surface 20 of the tread 2 in the case illustrated in FIG. 2. In a first non-limiting variant embodiment, the recessed elements 12 (also referred to as holes) are made up of openings 13 in the surface and associated cavities 14 that extend into the depth of the surface 20 and/or 30.

Thus, the linear motif 41 comprises a plurality of openings 13 in the surface, said openings 13 being distributed through the linear motif 41 at a density at least equal to one opening per square millimeter (mm²) and having, at the surface, equivalent diameters Dt of between 0.01 mm and 1.2 mm.

The openings 13 continue into the depth of the surface to form cavities 14.

The effect of these cavities 14 is to “trap” a large amount of the incident light rays that strike the linear motif 41, but also to make the texture 5 more durable. Specifically, since the cavities 12 are recessed into the surface, the impact of mechanical attack on the texture, such as rubbing by a road surface, is lower than for protrusions. In this second embodiment, the linear motif 41 makes it possible to obtain a visual appearance of the “velvet” type since the cavities absorb light and thus make the linear motifs 41 blacker and consequently make the marking 4 contrast more with the tire.

In one non-limiting embodiment, all or some of the cavities 14 have a depth at least equal to 0.1 mm. In one non-limiting variant embodiment, all or some of the cavities 14 have a depth of between 0.2 mm and 0.6 mm. This ensures that a large amount of incident light rays that strike the texture 5 are trapped by the linear motif 41 and, since the depth of the cavities is limited, also prevents the mechanical strength of the surface 20 and/or 30 from deteriorating excessively.

FIG. 10 illustrates the linear motif 41 according to a non-limiting variant of this second embodiment. In this variant, all or some of the cavities 14 are in the form of cones which extend into the depth of the surface 20 and/or 30 and lead onto the surface, forming circular openings 13. The cavities 13 thus have a cross section which decreases with depth into the surface. This improves the contrast of the linear motif 41 with the tread and/or sidewall. It will be noted that in this variant, the openings 13 of the cavities 14 are not in contact. The openings 13 are separated by intermediate zones 15. Moreover, the openings 13 are distributed regularly over all or some of the surface 20 and/or 30 such that the distance d between each opening in the linear motif 41 is similar overall.

FIG. 11 is a zoomed-in view of a cavity 14 of a recessed element 12 from FIG. 10. In one non-limiting embodiment, all or some of the cavities have at least one wall 16 which, in cross section, forms an angle β of between 10° and 60° with respect to a direction Z perpendicular to the linear motif 41.

Each time a light ray strikes a wall 16 of the cavity 14, this ray is reflected by said wall 16. The direction of reflection of the light ray depends on the initial direction of this light ray and on the inclination angle of the wall 16. Thus, depending on this initial direction and on this inclination angle, the light ray can be sent towards another wall 16 of the cavity. By contrast, the light ray can be sent to the outside of the cavity, for example directly towards an observer. In the first case, the light ray is “lost” in the cavity and will no longer be perceptible to an observer. In the second case, the observer can perceive the light ray and the texture can then appear to be lighter and thus to contrast less with the tread and/or sidewall. Choosing a cavity 14 having at least one wall 16 which forms an angle β of between 10° and 60° ensures that a large part of the light rays entering the cavity 14 will be absorbed by this cavity under the effect of multiple reflections inside the cavity. This improves the contrast of the linear motif 41 with the tread and/or sidewall, while retaining the same rate of occupation of the cavities in the linear motif 41. Moreover, with this wall inclination, the strength of the linear motif is improved overall, notably in the event of repeated rubbing against the road surface.

In a second non-limiting variant embodiment of the second embodiment, in which the linear motif 41 is made up of one or more recessed elements, the recessed elements are made up of a plurality of striations (not illustrated) that extend into the depth of the surface 20 and/or 30. Thus, a linear motif 41 can be made up of a plurality of striations having a locally variable width or a linear motif 41 is made up of only one striation (not illustrated), the width of which can vary locally.

When all or some of a strip 40 does not have a linear motif 41, a white colour is obtained. In this case, the white colour is realized by a smooth surface (that of the tread 2 and/or sidewall 3) which has very low surface roughness of parameter Ra. In one non-limiting example, the arithmetic mean deviation parameter Ra representing the surface roughness is less than 30 μm. This smooth surface reflects a maximum of incident light. The quantity of light reflected by all or some of a white strip 40 is thus maximized.

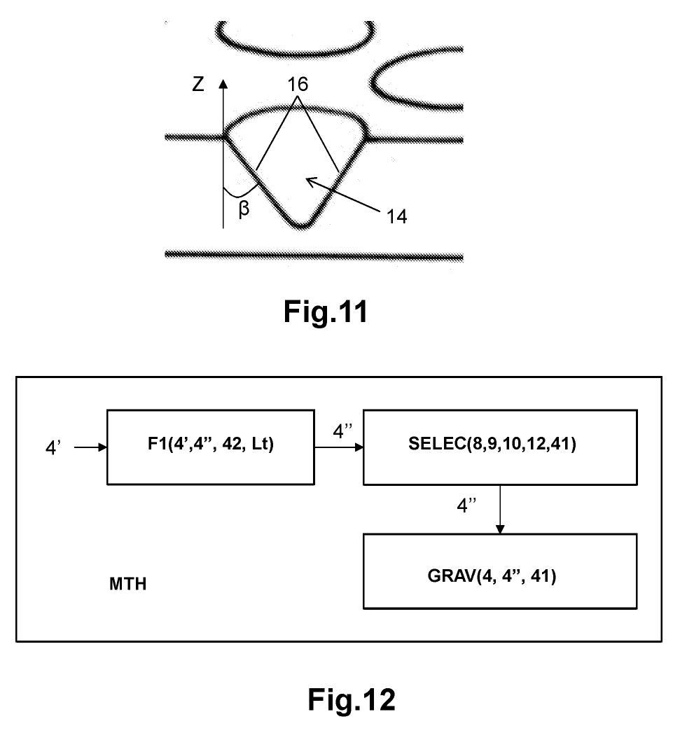

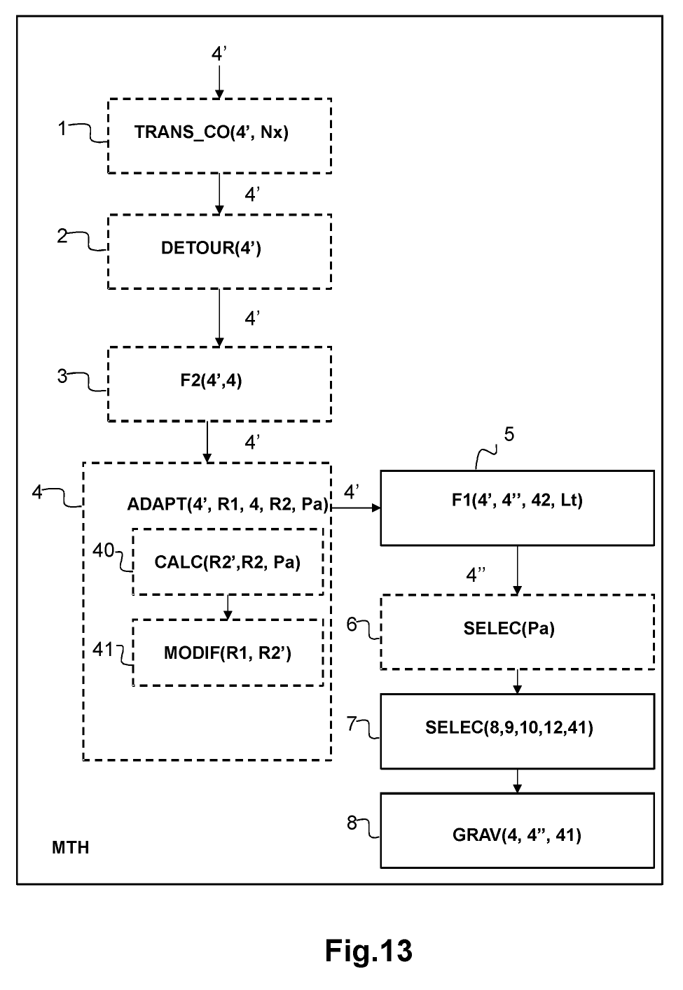

The marking 4 on the tire 1 made of rubber material comprising a tread 2 and a sidewall 3 is produced from a source image 4′ by means of a production method MTH illustrated in FIGS. 12 and 13.

It will be noted that the source image 4′ is an image in the form of a computer file such as files of the bitmap or jpeg type (also referred to as a digital image). Moreover, its resolution is generally fairly high, for example around 3000 pixels by 3000 pixels.

As illustrated in FIG. 12, the production method MTH comprises:
a first operation of processing the source image 4′ into a target image 4″ made up of a plurality of lines 42, all or some of the lines having one or more variations in width Lt along their length so as to define said source image 4′ (illustrated step F1(4′, 4″, 42, Lt));
the selection of one or more linear motifs 41 (illustrated step SELEC(8, 9, 10, 12, 41)); and
the realization of the marking 4 from said target image 4″, the marking comprising a plurality of linear motifs 41 (illustrated step GRAV(4, 4″, 41)).

The steps are described in more detail below.

The first operation of processing the source image 4′ will make it possible to obtain a target image 4″ made up of a plurality of lines 42 corresponding to the linear motifs 41 to be realized on the tire 1, all or some of the lines 42 having one or more variations in width Lt along their length so as to define said source image 4′. During this processing operation, the strips 40 of the target image 4″ are also defined. These strips 40 will thus allow the distribution and positioning of the lines 42 and thus the distribution and positioning of the linear motifs 41 in the marking 4 and aid the industrial production of said marking 4.

By virtue of the local variation in the width Lt of the lines 42 on the target image 4″, the subject of the source image 4′ is thus faithfully reproduced. The local variation in the width Lt of said line 42 will also make it possible to define the ultimate grey level Nx, as seen by an observer. Thus, during this step, both the aesthetic appearance of the marking 4 which will be provided on the tire 1 is determined by virtue of the positioning (oblique, horizontal, vertical) of the strips 40 in said digital image 4″, and the different grey levels of the source image 4′ are realized by means of the lines 42 realized in said strips, the different shades of grey being realized by the local variation in the lines 42 in the different parts 50. This processing operation is carried out by appropriate image processing software.

During the selection of one or more linear motifs 41, the protruding or recessed elements seen above are selected. The selected linear motifs 41 will thus be produced on the marking 4 depending on the lines 42 of the target image 4″ and notably depending on their positioning (oblique, horizontal, vertical) and the variation in their width.

In one non-limiting embodiment, the marking 4 is produced by laser etching by means of a laser etching machine M on a mould or directly on said tire 1 by means of the target image 4″ which is entered into the machine M as an input parameter.

In a first embodiment, the etching of the marking 4 is carried out on a mould. In a second embodiment, it is carried out directly on said tire 1. Thus, the etching of the marking 4 is carried out before or after the curing of the tire 1. Said etching comprises the etching of a plurality of linear motifs 41 to define the marking 4.

In one non-limiting example, the laser etching machine M is a pulsed laser which, in one non-limiting example, has a power of 50 W and a rate of 1000 mm/s and which functions at a frequency of 50 kHz.

In one non-limiting embodiment, the method also includes the definition of a spacing Pa between two linear motifs 41 which is set on the laser etching machine M (illustrated SELEC(Pb)). Thus, the spacing Pa is defined as an input parameter for the machine M. In one non-limiting embodiment, the spacing Pa is between 0.2 mm and 1 mm. This allows production on an industrial scale. It will be noted that the smaller the spacing Pa, the more precise the marking 4 will be. In one non-limiting embodiment, the spacing between two linear motifs Pa (also referred to as the etching spacing) corresponds to the width Lb of a strip 40. A spacing Pa between two adjacent linear motifs 41 is defined with respect to a median 43 that passes through each linear motif 41, as illustrated in FIG. 3.

This additional step (illustrated in dotted lines) can be carried out at any time in the production process, for example after the first processing operation.

It will be noted that if the source image 4′ is in colour, in one non-limiting embodiment, the method MTH also comprises conversion of the colour source image 4′ into a source image 4′ in grey levels (step TRANS_CO(4′, Nx) illustrated in FIG. 13).

Furthermore, in one non-limiting embodiment, the method MTH also comprises the cropping of the source image 4′. This makes it possible to better highlight the unit of meaning in the source image 4′ once it has been transferred onto the tire (step DETOUR(4′) illustrated in FIG. 13).

In one non-limiting embodiment, the method also includes a second processing operation (step F2(4′, p, Nx, L*) illustrated in FIG. 13) in which parameters p of the source image 4′ are set such that at least at least five percent of the grey levels Nx of said source image 4′ have a lightness value L* less than 20 and at least five percent of the grey levels Nx of said source image 4′ have a lightness value L* greater than 80. In one non-limiting example, these parameters p are the contrast and/or the lightness and/or the gamma parameter.

Thus, the source image 4′ is adjusted so as to obtain a marking 4 on the tire which is most similar to the source image 4′, notably by virtue of the adjustment of the gamma parameter (also referred to as gamma correction). It will be noted that it is possible to check the gamma correction by means of a histogram of the values of the pixels of the source image 4′.

The rubbers of which the tires are made are typically anthracite grey in colour. The maximum amplitude of contrast on these materials is low since the maximum lightness is around 25. This step therefore makes it possible to maximize the contrast made on the tire for an observer, on the background formed by the rubber material of the tire. The loss of the maximum amplitude of contrast brought about by the material is thus minimized.

The adjustment of the parameter of contrast makes it possible to clearly perceive the difference between the dark grey levels and the light grey levels.

This second processing operation makes it possible to obtain a marking 4 on the tire which has a lightness L* of between 8 and 25. Thus, the lightest zones of the marking 4 approach the lightness of 25 while the darkest zones of the marking 4 approach the lightness of 8. Grey levels are thus obtained on the marking 4 which are sufficiently visible on the tire to make said marking 4 stand out on the tire.

The step of converting the colour image (illustrated in dotted lines) is carried out before the second processing operation. The cropping step (illustrated in dotted lines) can be carried out before or after the second processing operation.

The first processing operation described above is carried out on the source image 4′ obtained after these three additional steps.

Finally, in one non-limiting embodiment, the method MTH also comprises adaptation of the resolution R1 of said source image 4′ depending on the desired resolution R2 of the marking 4 on said tire 1 and a spacing Pa between two linear motifs 41 (step ADAPT(4′, R1, 4, R2, Pa) illustrated in dotted lines in FIG. 13).

This allows fine control of the final rendering before carrying out etching during simulations and computer conversion, and makes it possible to prepare the running of the etching machine in accordance therewith.

The resolution R1 is the number of pixels which make up the source image 4′ in height and width. The resolution R2 is the number of millimeters which make up the marking 4 in height and width on the tire 1, namely the space on the tire 1 in millimeters that is dedicated to said marking 4.

The source image 4′ should in fact have a resolution R1 suitable for the visual effect ultimately desired on the tire 1.

The adaptation of said resolution R1 depending on the resolution R2 comprises the following sub-steps:

In a first sub-step (illustrated CALC(R2′, R2, Pb) in FIG. 13), the resolution R2′ of a digital image in pixels is calculated, corresponding to the resolution R2 of the target image 4 to be realized on the tire 1 in millimeters.

To this end, the resolution R2′ is equal to said resolution R2 divided by said spacing Pb. Thus, in one non-limiting example, if the available space for inscribing a marking 4 on the tire 1 is 30 mm×30 mm (resolution R2) and the spacing Pa of the etching is fixed at 0.3 mm (in the example in question the width of a strip 40), this means that it is possible to etch on the tire a marking corresponding to an image of resolution R2′ equal to 30 mm/0.3 mm=100 pixels×100 pixels. By virtue of this formula, a physical space available on the tire 1 is transcribed into a resolution of a digital image.

In a second step (illustrated MODIF(R1, R2′) in FIG. 13), depending on the calculated resolution R2′ in pixels corresponding to the resolution R2 of the marking 4, the resolution R1 of the source image 4′ is modified. Thus, the resolution R1, which was initially 3000×3000 pixels, is modified so as to obtain a new resolution R1 equal to 100×100 pixels. Thus, 30 pixels (=3000/100) of the source image 4′ with the old resolution R1 correspond to 1 pixel of the reduced source image 4′ with the new resolution RE This means that the grey level Nx defined by one pixel in the reduced source image 4′ is equal to the grey level Nx defined by a square of 30×30 pixels in the source image 4′ obtained just after the second processing operation in the example illustrated in FIG. 13.

This additional adaptation step ADAPT(4′, R1, 4, R2, Pb) is carried out before the step of processing the image FR1(4, 4″, 41, Lt).

FIG. 13 illustrates the method MTH for producing a marking 4 including these additional steps (conversion of the colour image, cropping and adaptation, selection of the spacing).

Thus, in a first step 1), the colour source image 4′ is converted into a source image 4′ comprising several grey levels Nx.

Next, in a second step 2), the image 4′ is cropped so as to retain only the unit of meaning; the eye, in the example in question.

In a third step 3), the parameters of said source image 4′ are adjusted.

In a fourth step 4), the resolution R1 of the source image 4′ is adapted depending on the desired resolution R2 of the marking 4 to be produced on the tire 1. This step comprises:
the sub-step 40) of calculating the resolution in pixels R2′ of an image depending on the resolution in millimeters of the marking 4 to be produced on the tire, namely the calculation of the resolution in pixels depending on the space dedicated to said marking 4 on the tire;
the sub-step 41) of modifying the resolution R1 of the source image 4′ depending on the calculated resolution in pixels R2′. The modification corresponds here to a reduction in the resolution R1.

In a fifth step 5), the source image 4′, the resolution R1 of which has been modified in order to define the target image 4″ made up of the plurality of strips 40, is processed. Thus, the strips 40 and the lines 42 of locally variable width Lt in said strips 40 are created so as to define the subject of the source image 4′ and consequently the different grey levels Nx of the source image 4′, the resolution of which has been modified.

In a sixth step 6), the laser etching machine M is set to the value of the spacing Pa, namely in this case with the value of a width Lb of a strip 40.

In a seventh step 7), the protruding and/or recessed elements that make up the linear motifs 41 are selected.

In an eighth step 8), the machine M produces the linear motifs 41 so as to realize the marking 4 on the tire 1.

It will be noted that the locations where the strip 40 does not have a linear motif 41 correspond to the colour white. Since the colour white is realized by the smooth surface of the tread and/or sidewall on which the marking 4 is located, the machine M does not etch these locations but etches only the linear motifs 41.

Thus, by virtue of this production method MTH, a marking 4 is realized which resembles the source image 4′ such that an observer of the tire will see a marking with sufficient contrast to allow them to recognize the subject of the marking. The marking 4 is made up of a plurality of grey levels which form, between one another, a contrast which restricts the final contrast obtained that the observer will be able to see from a minimum distance of 1 m.

The invention is not limited to the examples described and shown and various modifications can be made thereto without departing from its scope.

Thus, according to another non-limiting variant embodiment, the lamellae 9 from FIG. 8 can be discontinuous. They have a flat part between one another. They can also have cross-sectional differences between one another. In addition, the lamellae can have curves or angles, notably along their length. They can also have a variable length.

Thus, according to another non-limiting variant embodiment, the openings 13 from FIG. 10 can have a circular, square or polygonal (for example hexagonal) shape and the corresponding cavities 14 can have a cylindrical, parallelepipedal or polygonal shape. With these two latter structures (square or polygonal), it is possible to more easily organize the openings 13 with respect to one another so as to limit the surface area of the intermediate zones 15 between these openings. With such opening shapes, it is easier to achieve consistent rates of occupation of the openings.

Thus, according to another non-limiting variant embodiment, the tread 2 of the tire and/or the sidewall 3 can each have one or more markings 4.

Thus, according to another non-limiting variant embodiment, instead of using a technology of the velvet type to produce a linear motif 41, a linear motif 41 is produced by simple excavation carried out by the laser. In one non-limiting example, the excavation has a depth of between 0.1 and 0.5 mm.

Thus, according to another non-limiting variant embodiment, a linear motif 41 can vary locally in width with respect to a line extending along a strip 40, said line being different from the median line of said strip 40.

Thus, according to another non-limiting variant embodiment, the marking 4 can have linear motifs which do not extend over the entire marking 4, i.e. which do not extend from one limit of the marking to another limit.

In one variant embodiment, the linear motif extending from one limit of the marking to another limit has interruptions. In other words, the linear motif is discontinuous.

In another variant embodiment, the discontinuity spacing varies continuously so as to adapt to the curves of the tire.

In short, the method for realizing the marking comprises:
a first operation of processing the source image into a target image made up of a plurality of lines, all or some of the lines having one or more variations in width along their length so as to define said source image;
the selection of one or more linear motifs;
the realization of the marking from said target image, the marking comprising a plurality of linear motifs.

This method makes it possible to obtain grey levels on the marking which are sufficiently visible on the tire to make said image stand out on the tire.

In one non-limiting embodiment, the method also includes a second processing operation in which parameters of the source image are set such that at least five percent of the grey levels of said source image have a lightness value less than 20 and at least five percent of the grey levels of said source image have a lightness value greater than 80.

This makes it possible to obtain a marking on the tire which most closely resembles the source image.

In another non-limiting embodiment, the method also comprises adaptation of the resolution of said source image depending on the desired resolution of said marking on said tire and a spacing between two linear motifs.

This makes it possible to adapt the source image to the background of the tire. This makes it possible to transpose a marking in a physical space, in this case on the tire, into an image in a corresponding computer format.

In another non-limiting embodiment, the marking is produced by laser etching by means of a laser etching machine on a mould or directly on said tire.

Thus, the invention described has notably the following advantages:
It increases the quality of the markings perceived on a tire;
It makes it possible to realize high quality markings by means of already existing industrial techniques. The production costs are thus low;
It makes it possible to obtain a marking on the tire which makes it possible to recognize the subject of the source image;
It allows an observer of the tire to clearly perceive the marking on the tire, regardless of the direction and intensity of the light illuminating the tire, and not just when the light is low-angled;
It makes it possible to have precise markings on the tire: it is thus possible to obtain an image on the tire with photorealistic rendering;
It makes it possible to obtain a marking on the tire which has several shades of grey; and
It makes it possible to obtain a maximum contrast by virtue of a “velvet” type linear motif.

1. A fire made of rubber material, comprising a tread and a sidewall, said tire comprising a marking on said tread and/or said sidewall, in that wherein the marking is formed by a plurality of linear motifs formed integrally with the tire, said motifs being mutually parallel and spaced apart by a spacing P less than or equal to 1 mm, each linear motif having a length L, and wherein all or some of the linear motifs have one or more variation(s) in width along their length L, so as to define the marking.

2. The tire according to claim 1, wherein the marking is a representation of a photograph.

3. The tire according to claim 1, wherein the linear motifs are disposed obliquely in the marking.

4. The tire according to claim 1, wherein a linear motif is made up of one or more elements protruding from the tread and/or said sidewall and/or one or more elements recessed into the tread and/or said sidewall.

5. The tire according to claim 4, wherein all or some of the protruding elements are strands distributed through the linear motif at a density at least equal to one strand per square millimeter, each strand having a mean cross section of between 0.0005 mm² and 1 mm².

6. The tire according to claim 4, all or some of the protruding elements are substantially mutually parallel lamellae, the spacing of the lamellae in the linear motif being at most equal to 0.5 mm, each lamella having a mean width of between 0.02 mm and 0.25 mm.

7. The tire according to claim 4, wherein all or some of the protruding elements form parallelepipeds having a side length of between 0.05 mm and 0.5 mm and a height of between 0.05 mm and 0.5 mm, the distance between two adjacent parallelepipeds in the linear motif being between 0.05 mm and 0.5 mm.

8. The tire according to claim 4, wherein all or some of the recessed elements form openings in the tread and/or sidewall and the linear motif comprises a plurality of openings, these openings being distributed through the linear motif at a density at least equal to one opening per square millimeter, these openings having equivalent diameters of between 0.01 mm and 1.2 mm.

9. The tire according to claim 5, wherein all or some of the protruding elements are substantially mutually parallel lamellae, the spacing of the lamellae in the linear motif being at most equal to 0.5 mm, each lamella having a mean width of between 0.02 mm and 0.25 mm.
